(19) United States
(12) Patent Application Publication
(10) Pub. No.: US 2024/0149566 A1
(43) Pub. Date: May 9, 2024

(54) IMPACT-RESISTANT AND HEAT-INSULATING RESIN FILM

(71) Applicant: NAN YA PLASTICS CORPORATION, TAIPEI (TW)

(72) Inventors: TE-CHAO LIAO, TAIPEI (TW); CHUN-CHE TSAO, TAIPEI (TW)

(21) Appl. No.: 18/151,453

(22) Filed: Jan. 8, 2023

(30) Foreign Application Priority Data
Nov. 4, 2022 (TW) 111142112

(51) Int. Cl. B32B 27/08; B32B 7/12; B32B 27/36; B32B 33/00; B32B 37/12

(52) U.S. Cl. CPC B32B 27/08; B32B 7/12; B32B 27/36; B32B 33/00; B32B 37/12; B32B 2250/02; B32B 2255/10; B32B 2255/26; B32B 2307/304; B32B 2307/412; B32B 2307/558; B32B 2307/71; B32B 2310/0831

(57) ABSTRACT

An impact-resistant and heat-insulating resin film is provided, which includes a first transparent polymer film, a second transparent polymer film, a first transparent optical adhesive layer, and an infrared blocking coating layer. The first transparent polymer film has a tensile strength of not less than 60 MPa. The first transparent optical adhesive layer is adhered between the first transparent polymer film and the second transparent polymer film. The first transparent optical adhesive layer can block more than 90% of ultraviolet light having a wavelength of not greater than 400 nanometers. The infrared blocking coating layer is formed on a surface of the second transparent polymer film away from the first transparent polymer film. The infrared blocking coating layer can block more than 70% of infrared light having a wavelength of not less than 700 nanometers.

### CROSS-REFERENCE TO RELATED PATENT APPLICATION

This application claims the benefit of priority to Taiwan Patent Application No. 111142112, filed on Nov. 4, 2022. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a resin film, and more particularly to an impact-resistant and heat-insulating resin film.

### BACKGROUND OF THE DISCLOSURE

In recent years, with the rise of environmental awareness, there is a tendency of replacing most wall areas with glass curtains for keeping an appearance of a building. Accordingly, a lighting effect can be improved, which helps reduce the use of indoor lighting. However, ordinary glass is fragile. When the glass is damaged by an external force, glass fragments are likely to injure surrounding personnel. Furthermore, the use of a tempered glass in a large area will result in a significantly increased construction cost.

As shown in FIG. 1, a conventional explosion-proof film 1a in the related art includes a transparent base film 11a and an adhesive layer 12a. The conventional explosion-proof film 1a can be attached to a glass G (i.e., the glass curtain) through the adhesive layer 12a, so that an issue of the glass fragments flying across the air after the glass G is broken can be solved. However, although the large-area glass curtain can improve the lighting effect and reduce a utilization rate of indoor lighting, a penetration amount of infrared light L in sunlight will also be increased due to an increase in luminous flux illuminating an indoor space. During a summer period, an indoor temperature will be greatly increased, such that power consumption of an air conditioner is increased. As a result, the purpose of environmental protection, energy saving, and carbon reduction by use of the glass curtain is suppressed.

As shown in FIG. 2, one surface of the glass G facing an external environment can be attached with a conventional explosion-proof film 1b that includes a transparent base film 11b and an adhesive layer 12b. Another surface of the glass G facing the indoor space is attached with a conventional heat insulation film 2b that includes a transparent base film 21b, an adhesive layer 22b, and a heat insulation layer 23b. In this way, the glass G can have both explosion-proof and heat-insulating properties.

However, in order for the explosion-proof film 1b to prevent the glass fragments from flying across the air after being broken, the explosion-proof film 1b is generally designed to be externally attached (facing the external environment), so as to mitigate an impact force of a foreign object on the glass G. Moreover, weather resistance of the heat insulation film 2b is poor, so that the heat insulation film 2b is generally designed to be inwardly attached (facing the indoor space). That is, in the configuration of FIG. 2, two film attachment operations are required, thereby significantly increasing the complexity of the process and the construction cost.

Therefore, how to improve the weather resistance of the heat insulation film and allow the externally-attached explosion-proof film to have a heat-insulating property, so as to save the construction cost, is the technical problem to be solved in the present disclosure.

### SUMMARY OF THE DISCLOSURE

In response to the above-referenced technical inadequacies, the present disclosure provides an impact-resistant and heat-insulating resin film.

In one aspect, the present disclosure provides an impact-resistant and heat-insulating resin film that includes a first transparent polymer film, a first transparent optical adhesive layer, a second transparent polymer film, and an infrared blocking coating layer. The first transparent polymer film has a tensile strength of not less than 60 MPa. The first transparent optical adhesive layer has an ultraviolet blocking rate of not less than 90%. The first transparent optical adhesive layer is adhered between the first transparent polymer film and the second transparent polymer film. The infrared blocking coating layer is formed on a surface of the second transparent polymer film away from the first transparent optical adhesive layer. The infrared blocking coating layer has an infrared blocking rate of not less than 70%.

In certain embodiments, the first transparent polymer film has a thickness between 150 μm and 600 μm, the first transparent optical adhesive layer has a thickness between 1 μm and 50 μm, the second transparent polymer film has a thickness between 5 μm and 60 μm, and the infrared blocking coating layer has a thickness between 1 μm and 15 μm.

In certain embodiments, the first transparent polymer film is at least one material selected from the group consisting of: a polycarbonate (PC) transparent polymer film, an acrylonitrile butadiene styrene (ABS) copolymer transparent polymer film, and a polystyrene (PS) transparent polymer film.

In certain embodiments, the second transparent polymer film is at least one material selected from the group consisting of: a polyester transparent polymer film and a polymethyl methacrylate (PMMA) transparent polymer film.

In certain embodiments, the first transparent optical adhesive layer is made of an acrylic adhesive.

In certain embodiments, the first transparent optical adhesive layer further includes an ultraviolet absorber, and a weight percent concentration of the ultraviolet absorber in the first transparent optical adhesive layer is between 0.5 wt % and 3.0 wt %.

In certain embodiments, the infrared blocking coating layer is made of a melamine-formaldehyde resin and nano ceramic particles dispersed in the melamine-formaldehyde resin.

In certain embodiments, the nano ceramic particles are nano tungsten oxide particles. In the infrared blocking coating layer, a weight percent concentration of the nano ceramic particles is between 30 wt % and 60 wt %, and a weight percent concentration of the melamine-formaldehyde resin is between 40 wt % and 70 wt %.

In certain embodiments, after the infrared blocking coating layer is continuously irradiated by a QUV device having a wavelength of 313 nm for 2,000 hours, a change rate of an infrared blocking ability of the infrared blocking coating layer is not greater than 5%.

In certain embodiments, the impact-resistant and heat-insulating resin film further includes: a second transparent optical adhesive layer and a release film layer. The second transparent optical adhesive layer is adhered between the infrared blocking coating layer and the release film layer. The second transparent optical adhesive layer does not include any ultraviolet absorber. The impact-resistant and heat-insulating resin film is capable of being attached to a glass through the release film layer, and has a visible light transmittance of not less than 70% and a haze value of not greater than 5%.

Therefore, in the impact-resistant and heat-insulating resin film provided by the present disclosure, by virtue of “including a first transparent polymer film having a tensile strength of not less than 60 MPa, a second transparent polymer film, a first transparent optical adhesive layer adhered between the first transparent polymer film and the second transparent polymer film, and an infrared blocking coating layer formed on a surface of the second transparent polymer film away from the first transparent optical adhesive layer” and “the first transparent optical adhesive layer having an ultraviolet blocking rate of not less than 90%, and the infrared blocking coating layer having an infrared blocking rate of not less than 70%,” the impact-resistant and heat-insulating resin film can have both good impact resistance and heat insulation, and a construction cost for film attachment can be effectively reduced.

In practical application, the impact-resistant and heat-insulating resin film can be attached to a surface of a glass facing an external environment through the release film layer. The first transparent polymer film is disposed on an outermost layer of the resin film to face the external environment, and has impact resistance to mitigate an impact force of a foreign object. The first transparent polymer film can be, for example, a PC film or an ABS film having a tensile strength of not less than 60 MPa.

The first transparent optical adhesive layer is disposed on a second layer of the resin film. The first transparent optical adhesive layer is used to bond the first transparent polymer film and the second transparent polymer film together. The first transparent optical adhesive layer includes a trace amount of the ultraviolet absorber, so that the first transparent optical adhesive layer has an ultraviolet blocking rate of not less than 90% when light passes through the resin film. The first transparent optical adhesive layer can absorb ultraviolet light in sunlight to reduce a luminous flux of the ultraviolet light passing through the first transparent optical adhesive layer, can effectively prevent the second transparent polymer film (i.e., a PET transparent base film) from absorbing excessive ultraviolet light (which can result in deterioration or yellowing), and can also reduce an amount of the ultraviolet light entering an indoor environment.

The second transparent polymer film is disposed on a third layer of the resin film. The second transparent polymer film is a base film for coating the infrared blocking coating layer. The second transparent polymer film is made of a material (i.e., polyester or poly methyl methacrylate) that has good adhesion to the melamine-formaldehyde resin used in the infrared blocking coating layer.

The infrared blocking coating layer is disposed on a fourth layer of the resin film. The infrared blocking coating layer is formed on a surface of the second transparent polymer film away from the first transparent polymer film, and has good adhesion to the second transparent polymer film. The infrared blocking coating layer is made of a melamine-formaldehyde resin and nano ceramic particles dispersed therein. The infrared blocking coating layer has an infrared blocking rate of not less than 70%, so as to effectively reduce a luminous flux of infrared light in the sunlight. Accordingly, an indoor temperature can be lowered, and energy used by an air conditioning system can be saved. The second transparent optical adhesive layer is disposed between the infrared blocking coating layer and the release film layer, so as to bond the infrared blocking coating layer and the release film layer together.

Overall speaking, the resin film has both good impact resistance and heat insulation, and can be attached to a single side of the glass facing the external environment, thereby effectively reducing the construction cost.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic view showing a conventional explosion-proof film being attached to one side of a glass;

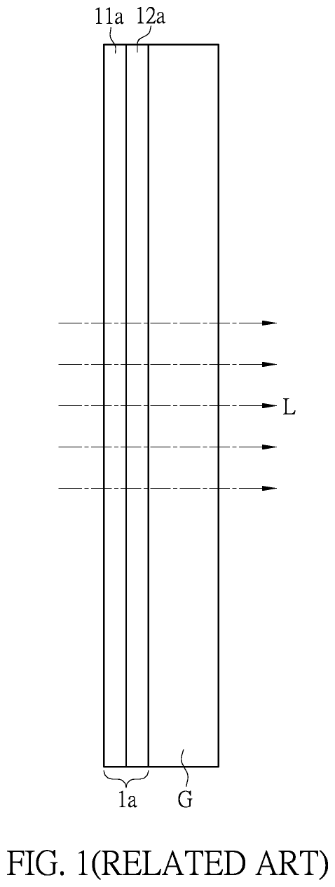

FIG. 2 is a schematic view showing the conventional explosion-proof film and a conventional heat insulation film being respectively attached to both sides of the glass;

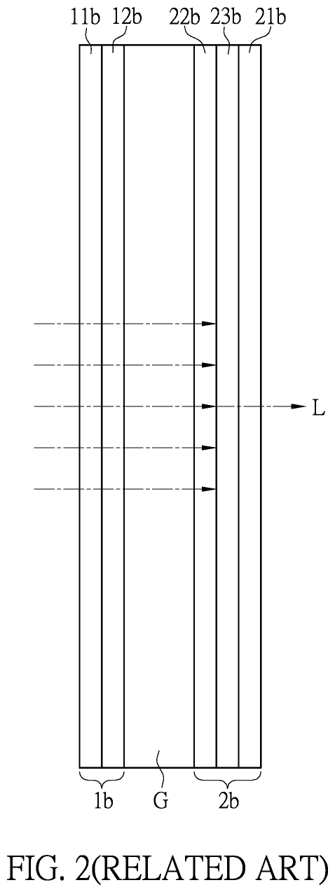

FIG. 3 is a schematic view of an impact-resistant and heat-insulating resin film according to an embodiment of the present disclosure;

FIG. 4 is a schematic view showing the impact-resistant and heat-insulating resin film being attached to one side of a glass according to the embodiment of the present disclosure; and

FIG. 5 is a schematic view of the impact-resistant and heat-insulating resin film in use according to the embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

### Impact-Resistant and Heat-Insulating Resin Film

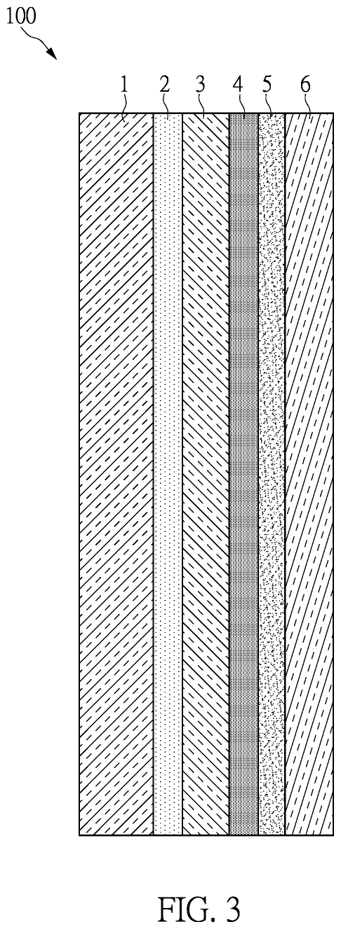

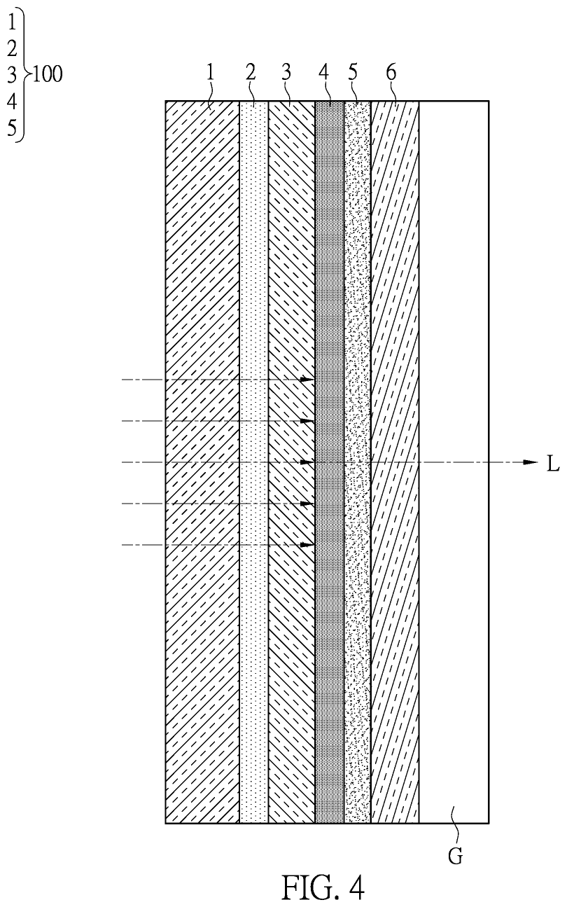

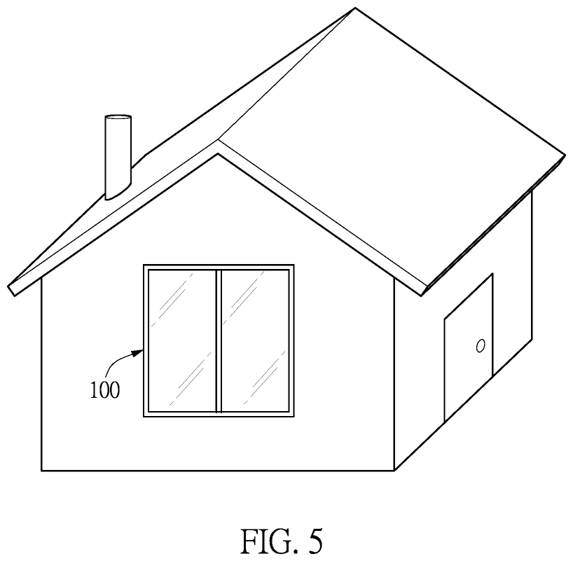

Referring to FIG. 3 to FIG. 5, an embodiment of the present disclosure provides an impact-resistant and heat-insulating resin film 100. FIG. 3 is a schematic view of an impact-resistant and heat-insulating resin film according to an embodiment of the present disclosure. FIG. 4 is a schematic view showing the impact-resistant and heat-insulating resin film being attached to one side of a glass according to the embodiment of the present disclosure. FIG. 5 is a schematic view of the impact-resistant and heat-insulating resin film in use according to the embodiment of the present disclosure.

The impact-resistant and heat-insulating resin film 100 includes: a first transparent polymer film 1, a first transparent optical adhesive layer 2, a second transparent polymer film 3, an infrared blocking coating layer 4, a second transparent optical adhesive layer 5, and a release film layer 6 that are stacked on each other.

Referring again to FIG. 3 and FIG. 4, the first transparent polymer film 1 is disposed on an outermost layer of the resin film 100 to face an external environment, and has an impact resistance to mitigate an impact force of a foreign object.

More specifically, the first transparent polymer film 1 has a tensile strength of not less than 60 MPa, and preferably not less than 75 MPa. In addition, the first transparent polymer film 1 has a thickness between 150 μm and 600 μm, and preferably between 200 μm and 500 μm. Therefore, the first transparent polymer film 1 can have sufficient impact resistance.

It should be noted that the unit of the tensile strength is “MPa”, and the tensile strength represents a maximum force that a film can withstand when being subjected to a tensile force. The measurement method of the tensile strength is carried out according to ASTM-D-882. Specifically, the measurement method includes: using a tensile testing machine to pull the film at a speed of 200 mm/min, and calculating the tensile strength of the film when the film is torn. The tensile strength is a value obtained by dividing a tensile load by a cross-sectional area of the film. The above tests are all carried out in an environment of a normal temperature (e.g., 25° C.) and a normal pressure (e.g., an atmospheric pressure).

In some embodiments of the present disclosure, the first transparent polymer film 1 is at least one material selected from the group consisting of: a polycarbonate (PC) transparent polymer film, an acrylonitrile butadiene styrene (ABS) copolymer transparent polymer film, and a polystyrene (PS) transparent polymer film. The first transparent polymer film 1 is preferably a PC transparent film or an ABS transparent film, but the present disclosure is not limited thereto.

The above-mentioned transparent polymer film can provide better impact resistance, and has good weather resistance and light transmittance (e.g., a visible light transmittance being greater than 80%).

Referring again to FIG. 3 and FIG. 4, the first transparent optical adhesive layer 2 is disposed between the first transparent polymer film 1 and the second transparent polymer film 3. The first transparent optical adhesive layer 2 is configured to bond the first transparent polymer film 1 and the second transparent polymer film 3 together. The first transparent optical adhesive layer 2 has a thickness between 1 μm and 50 μm, and preferably between 2 μm and 20 μm.

In some embodiments of the present disclosure, the first transparent optical adhesive layer 2 is made of an acrylic adhesive. The above-mentioned transparent optical adhesive can provide better adhesiveness and light transmittance (e.g., a visible light transmittance being greater than 80%).

Furthermore, the first transparent optical adhesive layer 2 further includes a trace amount of an ultraviolet absorber (UV absorber), and a weight percent concentration of the ultraviolet absorber added in the first transparent optical adhesive layer 2 is between 0.5 wt % and 3.0 wt %, so as to produce a sufficient ultraviolet absorption effect without affecting the light transmittance of the first transparent optical adhesive layer 2.

More specifically, the first transparent optical adhesive layer 2 including the ultraviolet absorber can block more than 90% (preferably 99%) of ultraviolet light having a wavelength of not greater than 400 nm (e.g., 300 nm to 380 nm) when light passes therethrough. That is, the first transparent optical adhesive layer 2 has an ultraviolet blocking rate of not less than 90%.

In some embodiments of the present disclosure, the ultraviolet absorber is at least one material selected from the group consisting of: salicylic acid esters, benzophenones, benzotriazoles, substituted acrylonitriles, triazines, and oxalanilides. Among them, the ultraviolet absorber is preferably a material selected from benzophenones.

It is worth mentioning that the purpose of adding a trace amount of the ultraviolet absorber to the first transparent optical adhesive layer 2 is to absorb the ultraviolet light in sunlight from the external environment, so as to reduce a luminous flux of the ultraviolet light passing through the first transparent optical adhesive layer 2 and to effectively prevent the second transparent polymer film 3 (e.g., a PET transparent base film) from absorbing excessive ultraviolet light (which can result in deterioration or yellowing). That is, adding a trace amount of the ultraviolet absorber to the first transparent optical adhesive layer 2 allows the weather resistance of the second transparent polymer film 3 to be increased.

Referring again to FIG. 3 and FIG. 4, the second transparent polymer film 3 has a thickness between 5 μm and 60 μm, and preferably between 10 μm and 50 μm.

It is worth mentioning that, in one embodiment of the present disclosure, the first transparent polymer film 1 can be, for example, a polycarbonate (PC) transparent polymer film, which has better impact resistance, weather resistance, and light transmittance. However, the polycarbonate (PC) transparent polymer film has poor adhesion to most resin materials, especially a melamine-formaldehyde resin used in the infrared blocking coating layer 4 as described below.

In order to improve the poor adhesion between the polycarbonate (PC) transparent polymer film and the melamine-formaldehyde resin, the second transparent polymer film 3 in some embodiments of the present disclosure is at least one material selected from the group consisting of: a polyester transparent polymer film and a polymethyl methacrylate (PMMA) transparent polymer film. In one exemplary embodiment of the present disclosure, the second transparent polymer film 3 is a polyethylene terephthalate (PET) transparent polymer film.

The above-mentioned second transparent polymer film 3 can provide better adhesion to the resin of the infrared blocking coating layer 4, and also has better light transmittance (e.g., a visible light transmittance being greater than 80%).

That is, the second transparent polymer film 3 is a base film for coating the infrared blocking coating layer 4.

Referring again to FIG. 3 and FIG. 4, the infrared blocking coating layer 4 is formed on a surface of the second transparent polymer film 3 away from the first transparent polymer film 1. In the present embodiment, the infrared blocking coating layer 4 is formed on the second transparent polymer film 3 by coating, but the present disclosure is not limited thereto.

The infrared blocking coating layer 4 has a thickness between 1 μm and 15 μm, and preferably between 3 μm and 10 μm.

The infrared blocking coating layer 4 is composed of the melamine-formaldehyde resin (MF resin) and nano ceramic particles dispersed in the melamine-formaldehyde resin.

In one exemplary embodiment of the present disclosure, the nano ceramic particles are nano tungsten oxide particles, which have an excellent infrared blocking effect.

Taking infrared blocking and light transmittance into consideration, the nano ceramic particles in the infrared blocking coating layer 4 have a weight percent concentration between 30 wt % and 60 wt %. Furthermore, the melamine-formaldehyde resin in the infrared blocking coating layer 4 has a weight percent concentration between 40 wt % and 70 wt %.

It is worth mentioning that the nano ceramic particles are adopted as the infrared absorber in the embodiment of the present disclosure for having better weather resistance than that of typical organic infrared absorbers.

The infrared blocking coating layer 4 is configured to block more than 70% (preferably 80%) of infrared light having a wavelength of not less than 700 nm (e.g., 760 nm to 2,500 nm) when the light passes therethrough. That is, the infrared blocking coating layer 4 has an infrared blocking rate of not less than 70%. Accordingly, the infrared blocking coating layer 4 can reduce a luminous flux of the infrared light in the sunlight, thereby lowering an indoor temperature and saving energy used by an air conditioning system.

It is worth mentioning that, in some embodiments of the present disclosure, the infrared blocking coating layer 4 has the following characteristic. After the infrared blocking coating layer 4 is continuously irradiated by a QUV device having a wavelength of 313 nm for 2,000 hours, a change rate of an infrared blocking ability of the infrared blocking coating layer 4 is not greater than 5%, and preferably not greater than 3%. Here, the QUV device adopts a Dewpanel Light Control Weather Meter FDP manufactured by Suga Test Instruments Co., Ltd. (test conditions: continuous irradiation by a UVA-313 lamp; 70° C.; 10% RH; irradiation intensity: 1.0 W/m²/nm).

Referring again to FIG. 3 and FIG. 4, the second transparent optical adhesive layer 5 is disposed between the infrared blocking coating layer 4 and the release film layer 6, so as to bond the infrared blocking coating layer 4 and the release film layer 6 together. The second transparent optical adhesive layer 5 has a thickness between 1 μm and 50 μm, and preferably between 2 μm and 20 μm.

In some embodiments of the present disclosure, the second transparent optical adhesive layer 5 is made of an acrylic adhesive. The above-mentioned transparent optical adhesive can provide better adhesiveness and light transmittance (e.g., a visible light transmittance being greater than 80%). Different from the above-mentioned first transparent optical adhesive layer 2, the second transparent optical adhesive layer 5 of the present embodiment does not include any ultraviolet absorber, and the second transparent optical adhesive layer 5 is only used for being attached to a glass G (i.e., a glass window) through the release film layer 6 (as shown in FIG. 4).

Referring again to FIG. 3 and FIG. 4, the release film layer 6 has a thickness between 5 μm and 60 μm, and preferably between 10 μm and 50 μm. The release film layer 6 is used for being attached to the glass G (as shown in FIG. 4).

In one exemplary embodiment of the present disclosure, the release film layer 6 is a polyester release film, and is more preferably a polyethylene terephthalate (PET) release film.

It should be noted that the impact-resistant and heat-insulating resin film 100 of the embodiment of the present disclosure needs to be attached to the glass G through the release film layer 6, so as to achieve a better light transmission effect. If the second transparent optical adhesive layer 5 or the infrared blocking coating layer 4 is directly attached to the glass G, its adhesion to the glass G may be poor, thereby affecting an overall visible light transmittance of the resin film 100.

Overall speaking, the resin film 100 of the embodiment of the present disclosure has both impact resistance and heat insulation properties, and has good weather resistance. The resin film 100 of the embodiment of the present disclosure can be applied to a glass curtain wall (as shown in FIG. 5) or an exterior of a car window, and can effectively reduce times of film attachment. The resin film 100 of the embodiment of the present disclosure has a high visible light transmittance (i.e., not less than 70%) and a low haze value (i.e., not greater than 5%). As such, the lighting effect of the original glass is not affected.

It should be noted that “the infrared blocking rate” mentioned in the present disclosure can be described as follows. When a glass having a heat insulation film attached thereto is irradiated by the infrared light in the sunlight (i.e., the light having a wavelength between 780 nm and 2,500 nm), one portion of the infrared light penetrates the heat insulation film, and another portion of the infrared light is absorbed by the heat insulation film A rate at which the infrared light is absorbed is referred to as the infrared blocking rate. A spectrophotometer can be used as an instrument for measuring infrared data in different bands and further calculating the infrared blocking rate.

It should be noted that “the ultraviolet blocking rate (UV blocking rate)” mentioned in the present disclosure can be described as follows. When a glass having an adhesive layer attached thereto is irradiated by the ultraviolet light in the sunlight (i.e., the light having a wavelength between 300 nm and 380 nm), one portion of the ultraviolet light penetrates the adhesive layer, and another portion of the ultraviolet light is absorbed by the adhesive layer. A rate at which the ultraviolet light is absorbed is referred to as the ultraviolet blocking rate. The spectrophotometer can be used as an instrument for measuring ultraviolet data in different bands and further calculating the ultraviolet blocking rate.

It should be noted that, for the description of “after the infrared blocking coating layer is continuously irradiated by a QUV device having a wavelength of 313 nm for 2,000 hours, a change rate of an infrared blocking ability of the infrared blocking coating layer is not greater than 5%” in the present disclosure, the change rate refers to a rate that reflects differences of the infrared blocking rate of the infrared blocking coating layer before and after being irradiated by the QUV device having the wavelength of 313 nm for 2,000 hours.

### Beneficial Effects of the Embodiments

In conclusion, in the impact-resistant and heat-insulating resin film provided by the present disclosure, by virtue of “including a first transparent polymer film having a tensile strength of not less than 60 MPa, a second transparent polymer film, a first transparent optical adhesive layer adhered between the first transparent polymer film and the second transparent polymer film, and an infrared blocking coating layer formed on a surface of the second transparent polymer film away from the first transparent optical adhesive layer; and “the first transparent optical adhesive layer having an ultraviolet blocking rate of not less than 90%, and the infrared blocking coating layer having an infrared blocking rate of not less than 70%,” the impact-resistant and heat-insulating resin film can have both good impact resistance and heat insulation, and a construction cost for film attachment can be effectively reduced.

As shown in FIG. 4, in practical application, the impact-resistant and heat-insulating resin film 100 can be attached to a surface of the glass G facing an external environment through the release film layer 6. The first transparent polymer film 1 is disposed on the outermost layer of the resin film 100 to face the external environment, and has impact resistance to mitigate an impact force of a foreign object. The first transparent polymer film 1 can be, for example, a PC film or an ABS film having a tensile strength of not less than 60 MPa.

The first transparent optical adhesive layer 2 is disposed on a second layer of the resin film 100. The first transparent optical adhesive layer 2 is used to bond the first transparent polymer film 1 and the second transparent polymer film 3 together. The first transparent optical adhesive layer 2 includes a trace amount of the ultraviolet absorber, so that the first transparent optical adhesive layer 2 has an ultraviolet blocking rate of not less than 90% when the light passes through the resin film 100. The first transparent optical adhesive layer 2 can absorb the ultraviolet light in the sunlight to reduce the luminous flux of the ultraviolet light passing through the first transparent optical adhesive layer 2, can effectively prevent the second transparent polymer film 3 (i.e., a PET transparent base film) from absorbing excessive ultraviolet light (which can result in deterioration or yellowing), and can also reduce an amount of the ultraviolet light entering an indoor environment.

The second transparent polymer film 3 is disposed on a third layer of the resin film 100. The second transparent polymer film 3 is a base film for coating the infrared blocking coating layer 4. The second transparent polymer film 3 is made of a material (i.e., polyester or poly (methyl methacrylate)) that has good adhesion to the melamine-formaldehyde resin used in the infrared blocking coating layer 4.

The infrared blocking coating layer 4 is disposed on a fourth layer of the resin film 100. The infrared blocking coating layer 4 is formed on a surface of the second transparent polymer film 3 away from the first transparent polymer film 1, and has good adhesion to the second transparent polymer film 3. The infrared blocking coating layer 4 is made of the melamine-formaldehyde resin and the nano ceramic particles dispersed therein. The infrared blocking coating layer 4 has an infrared blocking rate of not less than 70%, so as to effectively reduce the luminous flux of the infrared light in the sunlight. Accordingly, an indoor temperature can be lowered, and energy used by the air conditioning system can be saved. The second transparent optical adhesive layer 5 is disposed between the infrared blocking coating layer 4 and the release film layer 6, so as to bond the infrared blocking coating layer 4 and the release film layer 6 together.

Overall speaking, the resin film 100 has both good impact resistance and heat insulation, and can be attached to a single side of the glass G facing the external environment, thereby effectively reducing the construction cost.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

1. An impact-resistant and heat-insulating resin film suitable for use on a glass curtain wall, the resin film comprising:
a first transparent polymer film having a tensile strength of not less than 60 MPa,
wherein the first transparent polymer film is at least one of a polycarbonate (PC) transparent polymer film, an acrylonitrile butadiene styrene (ABS) copolymer transparent polymer film, and a polystyrene (PS) transparent polymer film, and the first transparent polymer film has a visible light transmittance greater than 80%;
a first transparent optical adhesive layer having an ultraviolet blocking rate of not less than 90%,
wherein the first transparent optical adhesive layer is an acrylic adhesive, and further includes an ultraviolet absorber; wherein a weight percent concentration of the ultraviolet absorber in the first transparent optical adhesive layer is between 0.5 wt % and 3.0 wt %, and the first transparent optical adhesive layer has a visible light transmittance greater than 80%;
a second transparent polymer film, wherein the first transparent optical adhesive layer is adhered between the first transparent polymer film and the second transparent polymer film,
wherein the second transparent polymer film is at least one of a polyester transparent polymer film and a polymethyl methacrylate (PMMA) transparent polymer film, and the second transparent polymer film has a visible light transmittance greater than 80%; and
an infrared blocking coating layer formed on a surface of the second transparent polymer film away from the first transparent polymer film, wherein the infrared blocking coating layer has an infrared blocking rate of not less than 70%,
wherein the ultraviolet absorber of the first transparent optical adhesive layer is able to absorb ultraviolet light from an external environment to prevent the second transparent polymer film from absorbing the ultraviolet light.

2. The impact-resistant and heat-insulating resin film according to claim 1, wherein the first transparent polymer film has a thickness between 150 μm and 600 μm, the first transparent optical adhesive layer has a thickness between 1 μm and 50 μm, the second transparent polymer film has a thickness between 5 μm and 60 μm, and the infrared blocking coating layer has a thickness between 1 μm and 15 μm.

3-6. (canceled)

7. The impact-resistant and heat-insulating resin film according to claim 1, wherein the infrared blocking coating layer is made of a melamine-formaldehyde resin and nano ceramic particles dispersed in the melamine-formaldehyde resin.

8. The impact-resistant and heat-insulating resin film according to claim 7, wherein the nano ceramic particles are nano tungsten oxide particles; wherein, in the infrared blocking coating layer, a weight percent concentration of the nano ceramic particles is between 30 wt % and 60 wt %, and a weight percent concentration of the melamine-formaldehyde resin is between 40 wt % and 70 wt %.

9. The impact-resistant and heat-insulating resin film according to claim 8, wherein, after the infrared blocking coating layer is continuously irradiated by a QUV device having a wavelength of 313 nm for 2,000 hours, a change rate of an infrared blocking ability of the infrared blocking coating layer is not greater than 5%.

10. The impact-resistant and heat-insulating resin film according to claim 8, further comprising: a second transparent optical adhesive layer and a release film layer, wherein the second transparent optical adhesive layer is adhered between the infrared blocking coating layer and the release film layer, and the second transparent optical adhesive layer does not include any ultraviolet absorber; wherein the impact-resistant and heat-insulating resin film has a visible light transmittance of not less than 70% and a haze value of not greater than 5%.
